(19) United States
(12) Patent Application Publication
(10) Pub. No.: US 2020/0277507 A1
(43) Pub. Date: Sep. 3, 2020

(54) AQUEOUS INK COMPOSITIONS

(71) Applicant: Hewlett-Packard Development Company, L.P., Spring, TX (US)

(72) Inventors: Jie ZHENG, San Diego, CA (US); Dennis Z. GUO, San Diego, CA (US)

(73) Assignee: Hewlett-Packard Development Company, L.P., Spring, TX (US)

(21) Appl. No.: 16/643,910

(22) PCT Filed: Jan. 10, 2018
(86) PCT No.: PCT/US2018/013083

§ 371 Date: Mar. 3, 2020

(51) Int. Cl. C09D 11/326; C08L 25/14; C08K 5/521; D06P 1/52; D06P 5/30

(52) U.S. Cl. CPC C09D 11/326; C08L 25/14; C08L 2201/54; D06P 1/5207; D06P 5/30; C08K 5/521

(57) ABSTRACT

The present disclosure is drawn to an aqueous ink composition, including from 60 wt % to 90 wt % water, from 4 wt % to 30 wt % organic co-solvent, and from 1 wt % to 6 wt % pigment. The aqueous ink composition can include a styrene acrylic polymer dispersant associated with a surface of the pigment and having a weight average molecular weight from 1,000 Mw to 50,000 Mw, and from 3 wt % to 15 wt % styrene C3-C5 alkyl (meth)acrylic polymer binder having a weight average molecular weight from 100,000 Mw to 500,000 Mw.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc. However, the permanence of printed ink on textiles can be an issue.

### BRIEF DESCRIPTION OF DRAWINGS

FIG. 1 schematically represents an example aqueous ink composition including a pigment that is dispersed by a styrene acrylic polymer dispersant, and is further co-dispersed with a styrene C3-C5 alkyl (meth)acrylic polymer binder;

FIG. 2 depicts an example textile printing system that includes an aqueous ink composition and a fabric substrate; and

FIG. 3 depicts an example method of textile printing in accordance with the present disclosure.

### DETAILED DESCRIPTION

Digital printing on cotton and other natural fabrics is often carried out using reactive and acid inks, which can contain toxic materials or chemicals that when washed after printing, can generate undesirable waste. On the other hand, water-based pigmented ink printing can be more environmentally friendly, but there have been drawbacks with respect to permanence, gamut, and/or other printing issues. Furthermore, pigmented ink compositions that are used tend to be suitable for piezo inkjet printing technologies and not so much for thermal inkjet printing technologies. Thus, pigmented ink formulations that can be inkjettable, including inkjettable from less expensive thermal inkjet architecture, can provide some advantages over many other pigmented ink compositions currently being used. Furthermore, an aqueous pigment-based inkjet ink that may be suitable for thermal inkjet printing, and that also can have good stability, jettability, color gamut, washfastness (durability through fabric washing cycles) on various natural fabrics can be desirable.

In accordance with this, the present disclosure is drawn to aqueous ink compositions, textile printing systems, and methods of textile printing. In one example, an aqueous ink composition can include from 60 wt % to 90 wt % water, from 4 wt % to 30 wt % organic co-solvent, and from 1 wt % to 6 wt % pigment having a styrene acrylic polymer dispersant associated with a surface of the pigment, the styrene acrylic polymer dispersant having a weight average molecular weight from 1,000 Mw to 50,000 Mw. The aqueous ink composition can also include from 3 wt % to 15 wt % styrene C3-C5 alkyl (meth)acrylic polymer binder having a weight average molecular weight from 100,000 Mw to 500,000 Mw. In one example, the styrene acrylic polymer dispersant can have a weight average molecular weight from 4,000 Mw to 30,000 Mw and an acid number from 100 mg/g to 350 mg/g. In another example, the styrene C3-C5 alkyl (meth)acrylic polymer binder can be a styrene butyl acrylic polymer binder and can have an acid number from 5 mg/g to less than 100 mg/g. In further detail, the styrene C3-C5 alkyl (meth)acrylic polymer binder can have an average particle size from 50 nm to 800 nm. In another example detail, the aqueous ink composition can also include from 0.1 wt % to 1.5 wt % of an anionic surfactant, such as, for example, a phosphate ester of a C10 to C20 alcohol, e.g., a polyethylene glycol (3) oleyl mono/di phosphate.

In another example, a textile printing system can include an aqueous ink composition and a fabric substrate, such as a treated or untreated natural fabric textile substrate. The aqueous ink composition can include from 60 wt % to 90 wt % water, from 4 wt % to 30 wt % organic co-solvent, and from 1 wt % to 6 wt % pigment having a styrene acrylic polymer dispersant associated with a surface of the pigment and having a weight average molecular weight from 1,000 Mw to 50,000 Mw. The aqueous ink composition can also include from 3 wt % to 15 wt % styrene C3-C5 alkyl (meth)acrylic polymer binder having a weight average molecular weight from 100,000 Mw to 500,000 Mw. In this example, the styrene acrylic polymer dispersant can have a weight average molecular weight from 4,000 Mw to 30,000 Mw and an acid number from 100 mg/g to 350 mg/g. In another example, the styrene C3-C5 alkyl (meth)acrylic polymer binder can be a styrene butyl acrylic polymer binder and can have an acid number from 5 mg/g to less than 100 mg/g. In further detail, the styrene C3-C5 alkyl (meth)acrylic polymer binder can have an average particle size from 50 nm to 800 nm. The aqueous ink composition can further include a nonionic surfactant, such as, for example, from 0.1 wt % to 1.5 wt % of a phosphate ester of a C10 to C20 alcohol, e.g., a polyethylene glycol (3) oleyl mono/di phosphate.

In another example, a method of textile printing can include ejecting an aqueous ink composition onto a fabric substrate, such as a treated or untreated natural fabric textile substrate. The aqueous ink composition can include from 60 wt % to 90 wt % water, from 4 wt % to 30 wt % organic co-solvent, and from 1 wt % to 6 wt % pigment having a styrene acrylic polymer dispersant associated with a surface of the pigment and having a weight average molecular weight from 1,000 Mw to 50,000 Mw. The aqueous ink composition can also include from 3 wt % to 15 wt % styrene C3-C5 alkyl (meth)acrylic polymer binder having a weight average molecular weight from 100,000 Mw to 500,000 Mw. In one example, the method can further include curing the aqueous ink composition on the fabric substrate at a temperature from 130° C. to 180° C. for from 1 to 5 minutes.

It is noted that when discussing the aqueous ink composition, the textile printing system, or the method of textile printing, each of these discussions can be considered applicable to other examples whether or not they are explicitly discussed in the context of that example. Thus, for example, in discussing a styrene acrylic dispersant related to the aqueous ink composition, such disclosure is also relevant to and directly supported in context of the textile printing system or the method of textile printing, and vice versa.

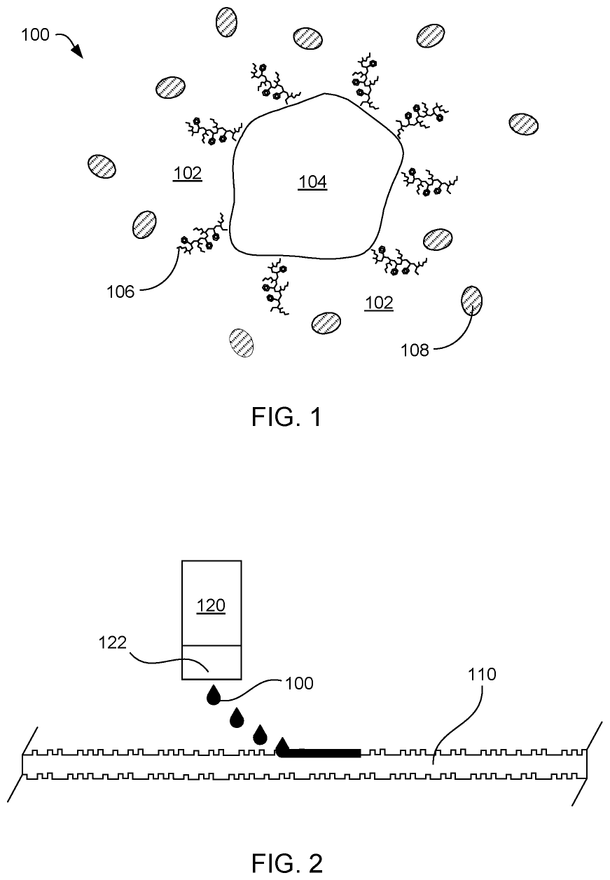

Turning now to FIG. 1, an aqueous ink composition 100 can include a liquid vehicle 102 with from 1 wt % to 6 wt % pigment 104 (or pigment particles or solids) dispersed therein. The pigment can be any of a number of pigments of any of a number of colors or black. Colors can include cyan, magenta, yellow, red, blue, violet, red, orange, green, etc. In one example, the aqueous ink composition can be a black ink with a carbon black pigment. In another example, the aqueous ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the aqueous ink composition can be a magenta ink with a quinacridone pigment or a co-crystal of a quinacridone pigment. Other exemplary quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the quinacridone can be a co-crystal of two quinacridone pigments, such as a co-crystal of PR122 and PV19, for example. In another example, the aqueous ink composition can be a yellow ink with an azo pigment, e.g., Pigment Yellow 74 and Pigment Yellow 155.

In the aqueous ink compositions 100 of the present disclosure, the pigments 104 can be dispersed by a styrene acrylic polymer dispersant 106. The dispersant can have a weight average molecular weight from 1,000 Mw to 50,000 Mw in one example, or from 4,000 Mw to 30,000 Mw in another example. In further detail, the styrene acrylic polymer dispersant can have a weight average molecular weight of 8,000 Mw to 28,000 Mw, or from 10,000 Mw to 20,000 Mw. The styrene acrylic polymer dispersant can have an acid number from 100 mg/g to 350 mg/g, from 120 mg/g to 350 mg/g, from 150 mg/g to 300 mg/g, or from 150 mg/g to 225 mg/g, for example. Exemplary commercially available styrene acrylic polymer dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl® 696, Joncryl® ECO 675, Joncryl® 693, Joncryl® 695, or others (all available from BASF Corp., Germany). In other examples, the styrene acrylic polymer dispersant can be prepared with the pigment, which is then admixed with other ink compositions as described herein.

In further detail, the aqueous ink compositions 100 can also include a styrene C3-C5 alkyl (meth)acrylic polymer binder 108 at a relatively high content, e.g., from 3 wt % to 15 wt %, from 5 wt % to 10 wt %, or from 6 wt % to 8 wt %, for example. It is noted that the term “(meth)acrylic” is intended to independently describe both acrylic polymers as well as methacrylic polymers. Example styrene C3-C5 alkyl (meth)acrylic polymer binders that can be suitable for use include styrene propyl acrylic polymer binders, styrene butyl acrylic polymer binders, styrene pentyl acrylic polymer binders, styrene propyl methacrylic polymer binders, styrene butyl methacrylic polymer binders, or styrene pentyl methacrylic polymer binders. The propyl group, the butyl group, or the hexyl group can be a straight chained C3-C5 alkyl group, or a branched C3-C5 alkyl group, for example. In one specific example, the styrene C3-05 (meth)acrylic polymer binder can be a styrene butyl acrylic polymer binder, such as that available under the tradename Jantex™, e.g., Jantex™ 45NRF or Jantex™ 924 (from Jantex Inks, USA). The weight average molecular weight of the styrene C3-C5 alkyl (meth)acrylic polymer binder, including specifically the styrene butyl acrylic polymer binder example, can be from 100,000 Mw to 500,000 Mw, or from 140,000 Mw to 320,000 Mw. The acid number of the styrene C3-C5 alkyl (meth)acrylic polymer binder generally, as well as more specifically the styrene butyl acrylic polymer binder example, can be from 5 mg/g to less than 100 mg/g, from 10 mg/g to less than 100 mg/g, from 5 mg/g to 50 mg/g, or from 5 mg/g to 20 mg/g, for example. In further detail, the styrene C3-C5 alkyl (meth)acrylic polymer binder can have an average particle size from 50 nm to 800 nm, from 100 nm to 600 nm, or from 200 nm to 500 nm, for example.

As mentioned, the aqueous ink compositions 100 of the present disclosure can be formulated to include an aqueous liquid vehicle 102, which can include the water content, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, other colorant, etc. However, as part of the ink composition, pigment, the styrene acrylic polymer dispersant, and the styrene C3-C5 alkyl (meth)acrylic polymer binder can be included or carried by the liquid vehicle components.

In further detail regarding the aqueous liquid vehicle, co-solvent(s) of the aqueous liquid vehicle can be any co-solvent or combination of co-solvents that is compatible with the pigment, dispersant, and binder. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The aqueous liquid vehicle can also include surfactant. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol surfactant, e.g., Surfynol 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda, United Kingdom). The surfactant or combinations of surfactants, if present, can be included in the ink composition at from about 0.01 wt % to about 5 wt % and, in some examples, can be present at from about 0.05 wt % to about 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents such as EDTA (ethylene diamine tetra acetic acid) may be included to eliminate the deleterious effects of heavy metal impurities, and buffer solutions may be used to control the pH of the ink. Viscosity modifiers and buffers may also be present, as well as other additives known to those skilled in the art to modify properties of the ink as desired.

As shown in FIG. 2, the aqueous ink compositions 100 can be printed on fabric substrates 110. For example, the aqueous ink compositions can be printed from an inkjet pen 120 which includes an ejector 122, such as a thermal inkjet ejector, for example. These aqueous ink compositions can be suitable for printing on many types of textiles, but can be particularly acceptable on treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Treated fabrics can include a coating, for example, such as a coating including a cationic component such as calcium salt, magnesium salt, cationic polymer, etc. These types of substrates can provide acceptable optical density (OD) and/or washfastness properties. The term “washfastness” can be defined as the OD or delta E (ΔE) that is retained after five (5) standard washing machine cycles using warm water and a standard clothing detergent (e.g., Tide® available from Proctor and Gamble, Cincinnati, Ohio, USA). Essentially, by measuring OD and/or L*a*b* both before and after washing, ΔOD and ΔE value can be determined, which is essentially a quantitative way of expressing the difference between the OD and/or L*a*b*prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the problematic blue region at hue angles of about 275°), ii) compensation for neutral colors or the primed values in the L*C*h differences, iii) compensation for lightness (S_{L}), iv) compensation for chroma (S_{C}), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} and ΔE₂₀₀₀ are used.

In further detail regarding the fabric substrates, the fabric can include a substrate, and in some examples can be treated, such as with a coating that includes a calcium salt, a magnesium salt, a cationic polymer, or a combination of a calcium or magnesium salt and cationic polymer. Fabric substrates can include substrates that have fibers that may be natural and/or synthetic, but in some examples, the fabric is particularly useful with natural fabric substrates. The fabric substrate can include, for example, a textile, a cloth, a fabric material, fabric clothing, or other fabric product suitable for applying ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” does not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into a finished article (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of two or more of these processes.

Regardless of the structure, in one example, the fabric substrate can include natural fibers, synthetic fibers, or a combination thereof. Exemplary natural fibers can include, but are not limited to, wool, cotton, silk, linen, jute, flax, hemp, rayon fibers, thermoplastic aliphatic polymeric fibers derived from renewable resources (e.g. cornstarch, tapioca products, sugarcanes), or a combination thereof. In another example, the fabric substrate can include synthetic fibers. Exemplary synthetic fibers can include polymeric fibers such as, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the synthetic fiber can be a modified fiber from the above-listed polymers. The term “modified fiber” refers to one or both of the polymeric fiber and the fabric as a whole having undergone a chemical or physical process such as, but not limited to, one or more of a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation. The term “PVC-free fibers” as used herein means that no polyvinyl chloride (PVC) polymer or vinyl chloride monomer units are in the fibers.

As previously mentioned, the fabric substrate can be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber. The amount of each fiber type can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from about 10 gsm to about 500 gsm. In another example, the fabric substrate can have a basis weight ranging from about 50 gsm to about 400 gsm. In other examples, the fabric substrate can have a basis weight ranging from about 100 gsm to about 300 gsm, from about 75 gsm to about 250 gsm, from about 125 gsm to about 300 gsm, or from about 150 gsm to about 350 gsm.

In addition the fabric substrate can contain additives including, but not limited to, one or more of colorant (e.g., pigments, dyes, and tints), antistatic agents, brightening agents, nucleating agents, antioxidants, UV stabilizers, fillers and lubricants, for example. Alternatively, the fabric substrate may be pre-treated in a solution containing the substances listed above before applying other treatments or coating layers.

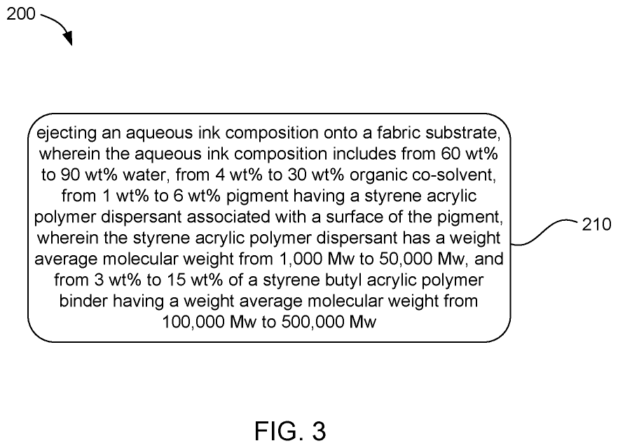

In another example, and as set forth in FIG. 3, a method 200 of textile printing can include ejecting 210 an aqueous ink composition onto a fabric substrate, such as a treated or untreated natural fabric textile substrate. The ejecting step can be carried out with some of the aqueous ink compositions of the present disclosure using thermal inkjet architecture, such as a thermal printhead resistor and a jetting orifice, for example. The aqueous ink composition can include from 60 wt % to 90 wt % water, from 4 wt % to 30 wt % organic co-solvent, and from 1 wt % to 6 wt % pigment having a styrene acrylic polymer dispersant associated with a surface of the pigment and having a weight average molecular weight from 1,000 Mw to 50,000 Mw. The aqueous ink composition can also include from 3 wt % to 15 wt % styrene C3-C5 alkyl (meth)acrylic polymer binder having a weight average molecular weight from 100,000 Mw to 500,000 Mw. In one example, the method can further include curing the aqueous ink composition on the fabric substrate at a temperature from 130° C. to 180° C. for from 1 to 5 minutes.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

The term “acid value” or “acid number” refers to the mass of potassium hydroxide (KOH) in milligrams that can be used to neutralize one gram of substance (mg/g), such as the various polymers disclosed herein, e.g.; styrene acrylic polymer dispersant and/or styrene C3-C5 alkyl (meth)acrylic polymer binder.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is only exemplary or illustrative of the application of the principles of the presented formulations and methods. Numerous modifications and alternative methods may be devised by those skilled in the art without departing from the spirit and scope of the present disclosure. The appended claims are intended to cover such modifications and arrangements. Thus, while the technology has been described above with particularity, the following provide further detail in connection with what are presently deemed to be the acceptable examples.

### Example 1—Preparation of Ink Compositions

Fifteen ink compositions were prepared in accordance with the general formula shown in Table 1, with further detail provided in Table 2, as follows:

TABLE 1

| Component | Weight % |
|---|---|
| ¹Pigment | 3 |
| (²styrene acrylic polymer dispersant) | |
| ³Styrene butyl acrylic polymer binder | 6 |
| Glycerol | 8 |
| LEG-1 | 1 |
| ⁴Crodafos ® N3A | 0.5 |
| ⁵Surfynol ® 440 | 0.3 |
| ⁶Acticide ® B20 | 0.22 |
| Deionized Water | Balance |

¹Carbon Black Pigment (4 black ink compositions); Copper Phthalocyanine Pigment (3 cyan ink compositions); Quinacridone Pigment (4 magenta ink compositions); and Azo Pigment (4 yellow ink compositions).
²Various styrene acrylic polymer dispersants ranging from 8,000 Mw to 17,250 Mw with an acid number ranging from 155 mg/g to 214 mg/g.
³Jantex ™ 45NRF or Jantex 924 ™, available from Jantexinks, (USA); Jantex ™ weight average molecular weight from 140,000 Mw to 320,000 Mw and acid number from 5 to 20 mg/g (Jantex ™ 45NRF about 150,000 Mw, AN 9; Jantex 924 ™ 230,000 Mw to 300,000 Mw, AN 16)
⁴Crodafos ™ is available from Croda ® International Plc. (Great Britain).
⁵Surfynol ® is available from Evonik, (Canada).
⁶Acticide ® is available from Thor Specialties, Inc. (USA).

TABLE 2

| | | | Styrene Butyl |
|---|---|---|---|
| | | Styrene Acrylic | Acrylic Polymer |
| | | Polymer Dispersant | Binder (Weight |
| | | (Weight Average | Average Molecular |
| Ink | | Molecular Weight | Weight and Acid |
| ID | Pigment | and Acid Number) | Number) |
| K1 | Carbon | 8,000 Mw; 155 mg/g | Jantex ™ 45NRF |
| | Black | | |
| K2 | Carbon | 8,000 Mw; 155 mg/g | Jantex ™ 45NRF |
| | Black | | |
| K3 | Carbon | 8,000 Mw; 155 mg/g | Jantex ™ 924 |
| | Black | | |
| K4 | Carbon | 8,000 Mw; 155 mg/g | Jantex ™ 924 |
| | Black | | |
| C1 | PB15:3 | 17,250 Mw; 214 mg/g | Jantex ™ 45NRF |
| C2 | PB15:3 | 8,000 Mw; 185 mg/g | Jantex ™ 924 |
| C3 | PB15:3 | 17,250 Mw; 214 mg/g | Jantex ™ 924 |
| M1 | PR122/PV19 | 10,000 Mw; 172 mg/g | Jantex ™ 45NRF |
| | co-crystal | | |
| M2 | PR122 | 17,250 Mw; 214 mg/g | Jantex ™ 45NRF |
| M3 | PR122/PV19 | 10,000 Mw; 172 mg/g | Jantex ™ 924 |
| | co-crystal | | |
| M4 | P122 | 17,250 Mw; 214 mg/g | Jantex ™ 924 |
| Y1 | PY74 | 11,000 Mw; 185 mg/g | Jantex ™ 45NRF |
| Y2 | PY74 | 8,000 Mw; 165 mg/g | Jantex ™ 45NRF |
| Y3 | PY74 | 11,000 Mw; 185 mg/g | Jantex ™ 924 |
| Y4 | PY74 | 8,000 Mw; AN 165 mg/g | Jantex ™ 924 |

### Example 2—Pigment Stability in Ink Compositions

Particle size distribution data was collected for the fifteen (15) ink compositions prepared in accordance with Example 1. Specifically, both the volume averaged particle size (Mv) was collected, as well as the particle size at which 95% of the particles (based on number of particles) were smaller and 5% were larger (D95). The initial particle size data was collected using a NanoTrac® 150 particle size system. The pigment particle sizes (both Mv and D95) were then determined again using the NanoTrac® 150 system after undergoing either freeze-thaw cycling (T-cycle) or accelerated shelf-life (ASL) stress.

The freeze-thaw cycling (T-cycle) included 5 freeze-thaw cycles where 30 mL samples were brought to an initial temperature of 70° C. in 20 minutes, and then maintained at 70° C. for 4 hours. The samples were then decreased from 70° C. to −40° C. in 20 minutes and maintained at −40° C. for 4 hours. This process was repeated, such that each sample was subjected to a total of 5 freeze-thaw cycles. Following the fifth cycle, the samples were allowed to equilibrate to room temperature and the Mv and D95 particle sizes were tested.

With respect to accelerated shelf-life (ASL), 30 mL samples were stored in an oven at 60° C. for 7 days. Following the elevated temperature storage period, the samples were allowed to equilibrate to room temperature and the particle sizes (Mv and D95) were tested.

The results of the stability testing are shown in Tables 3A and 3B, where T-cycle=5 Freeze-Thaw Cycles from −40° C. to 70° C.; ASL=Accelerated Shelf Life (ASL) at 60° C. for 1 week; Mv=Volume Averaged Particle Size; D95=95 Percentile Particle Size; and %Δ=Percentile Change from Initial Particle Size (Mv or D95) Compared to After T-cycle or ASL.

TABLE 3A
Volume Averaged Particle Size Stability

| Ink | Initial Mv | T-cycle Mv | T-cycle Mv | ASL Mv | ASL Mv |
|---|---|---|---|---|---|
| ID | (μm) | (μm) | (% Δ) | (μm) | (% Δ) |
| K1 | 0.211 | 0.203 | −3.8 | 0.206 | −2.4 |
| K2 | 0.154 | 0.153 | −0.5 | 0.161 | 4.1 |
| K3 | 0.136 | 0.132 | −2.4 | 0.132 | −2.4 |
| K4 | 0.127 | 0.129 | 1.5 | 0.128 | 1.1 |
| C1 | 0.116 | 0.119 | 2.8 | 0.117 | 0.3 |
| C2 | 0.103 | 0.102 | −1.0 | 0.098 | −4.4 |
| C3 | 0.119 | 0.119 | 0.3 | 0.119 | 0.2 |
| M1 | 0.142 | 0.144 | 1.4 | 0.141 | −0.1 |
| M2 | 0.136 | 0.140 | 2.7 | 0.140 | 2.5 |
| M3 | 0.134 | 0.134 | 0.4 | 0.130 | −2.7 |
| M4 | 0.141 | 0.154 | 8.8 | 0.145 | 2.7 |
| Y1 | 0.116 | 0.119 | 2.1 | 0.128 | 9.7 |
| Y2 | 0.152 | 0.169 | 11.6 | 0.159 | 4.5 |
| Y3 | 0.127 | 0.124 | −2.8 | 0.124 | −2.3 |
| Y4 | 0.159 | 0.158 | −0.6 | 0.159 | −0.1 |

TABLE 3B
D95 Particle Size Stability

| Ink | Initial D95 | T-cycle D95 | T-cycle D95 | ASL D95 | ASL D95 |
|---|---|---|---|---|---|
| ID | (μm) | (μm) | (% Δ) | (μm) | (% Δ) |
| K1 | 0.582 | 0.518 | −11.0 | 0.546 | −6.2 |
| K2 | 0.466 | 0.404 | −13.3 | 0.464 | −0.4 |
| K3 | 0.235 | 0.233 | −1.1 | 0.236 | 0.3 |
| K4 | 0.220 | 0.225 | 2.1 | 0.230 | 4.6 |
| C1 | 0.204 | 0.215 | 5.3 | 0.214 | 4.7 |
| C2 | 0.168 | 0.170 | 1.1 | 0.164 | −2.2 |
| C3 | 0.195 | 0.195 | 0.5 | 0.196 | 0.5 |
| M1 | 0.411 | 0.397 | −3.4 | 0.404 | −1.7 |
| M2 | 0.462 | 0.479 | 3.7 | 0.495 | 7.1 |
| M3 | 0.223 | 0.222 | −0.3 | 0.230 | 3.1 |
| M4 | 0.239 | 0.254 | 6.3 | 0.248 | 3.7 |
| Y1 | 0.379 | 0.387 | 2.1 | 0.422 | 11.3 |
| Y2 | 0.400 | 0.425 | 6.2 | 0.403 | 0.8 |
| Y3 | 0.223 | 0.224 | 0.8 | 0.226 | 1.4 |
| Y4 | 0.269 | 0.268 | −0.3 | 0.274 | 2.0 |

As can be seen in Tables 3A and 3B, the particle size stability for the pigments in the ink compositions was very good both with respect to Mv and D95 under T-cycle and ASL testing protocols. Ink composition samples that included pigments changing in size by more than 10% only did so in one of the four categories, e.g., % Δ Mv T-cycle, % Δ Mv ASL, % Δ D95 T-cycle, and % Δ D95 ASL.

### Example 3—Washfastness

Six (6) of the ink compositions of Example 1 were printed on various fabric substrates, including Jacquard Percale cotton (treated with an alkaline earth metal salt and a cationic polymer), gray cotton (untreated), and silk (untreated). The remaining nine (9) ink compositions were also printed on the gray cotton (untreated). The print pattern printed on the various fabric substrates were 3 drops per pixel durability plots, where each drop was about 12 ng in volume, from a thermal inkjet printhead at 3 drops per pixel. After printing, the printed durability plots were allowed to dry and then cured under heat (150° C. for 2 minutes for ink composition samples containing Jantex™ 45NRF, and 3 minutes for ink compositions containing Jantex™ 924). The various samples (6 ink compositions printed on three different fabric substrates and 9 remaining ink compositions printed only on gray cotton) were then evaluated to obtain optical density and L*a*b* color space values, which represented the “pre-washing” values, or reference black or color values. Then, the printed fabric substrates were washed at 40° C. with laundry detergent (e.g., Tide® available from Proctor and Gamble, Cincinnati, Ohio, USA) for 5 cycles, air drying the printed fabric substrates between each washing cycle. After the five cycles, optical density (OD) and L*a*b* values were measured for comparison, and delta E (ΔE) values were calculated using both the 1976 ΔE_{CIE} and ΔE₂₀₀₀ standards. The data is shown in Tables 4A-4C below.

TABLE 4A
Jacquard Cotton (Treated)

| Ink | OD | OD | | % | | |
|---|---|---|---|---|---|---|
| ID | (Pre-Wash) | (Post-Wash) | ΔOD | ΔOD | ΔE_{CIE} | ΔE₂₀₀₀ |
| K1 | 1.230 | 1.222 | −0.008 | −0.65 | 1.61 | 1.48 |
| C1 | 1.216 | 1.182 | −0.034 | −2.78 | 1.57 | 0.84 |
| M1 | 1.121 | 1.121 | 0.000 | −0.02 | 1.46 | 1.05 |
| M2 | 1.058 | 1.065 | 0.006 | 0.61 | 1.12 | 0.75 |
| Y1 | 1.133 | 1.123 | −0.010 | −0.90 | 1.08 | 0.40 |
| Y2 | 1.147 | 1.139 | −0.008 | −0.74 | 1.81 | 0.83 |

TABLE 4B
Gray Cotton (Untreated)

| Ink | OD | OD | | % | | |
|---|---|---|---|---|---|---|
| ID | (Pre-Wash) | (Post-Wash) | ΔOD | ΔOD | ΔE_{CIE} | ΔE₂₀₀₀ |
| K1 | 1.153 | 1.082 | −0.071 | −6.15 | 2.90 | 2.38 |
| K2 | 1.170 | 1.110 | −0.060 | −5.13 | 3.10 | 2.54 |
| K3 | 1.149 | 1.133 | −0.016 | −1.39 | 0.94 | 0.77 |
| K4 | 1.154 | 1.111 | −0.043 | −3.73 | 0.87 | 0.71 |
| C1 | 1.126 | 1.054 | −0.072 | −6.38 | 2.52 | 1.32 |
| C2 | 1.170 | 1.146 | −0.025 | −2.09 | 1.51 | 0.79 |
| C3 | 1.164 | 1.129 | −0.035 | −3.01 | 2.00 | 1.13 |
| M1 | 1.093 | 1.024 | −0.069 | −6.32 | 3.46 | 1.20 |
| M2 | 1.002 | 0.940 | −0.062 | −6.19 | 4.00 | 1.71 |
| M3 | 1.074 | 1.063 | −0.011 | −1.02 | 1.87 | 0.71 |
| M4 | 1.018 | 0.975 | −0.043 | −4.22 | 3.08 | 1.25 |
| Y1 | 1.092 | 0.993 | −0.099 | −9.03 | 4.97 | 1.07 |
| Y2 | 1.083 | 1.026 | −0.057 | −5.26 | 3.05 | 0.65 |
| Y3 | 1.100 | 1.069 | −0.032 | −2.86 | 1.53 | 0.41 |
| Y4 | 1.068 | 1.034 | −0.035 | −3.23 | 1.74 | 0.45 |

TABLE 4C
Silk (Untreated)

| Ink | OD | OD | | % | | |
|---|---|---|---|---|---|---|
| ID | (Pre-Wash) | (Post-Wash) | ΔOD | ΔOD | ΔE_{CIE} | ΔE₂₀₀₀ |
| K1 | 1.274 | 1.110 | −0.164 | −12.84 | 5.70 | 4.43 |
| C1 | 1.151 | 0.939 | −0.213 | −18.46 | 9.15 | 6.59 |
| M1 | 1.211 | 1.087 | −0.124 | −10.22 | 4.88 | 2.44 |
| M2 | 1.095 | 0.921 | −0.174 | −15.85 | 7.61 | 4.38 |
| Y1 | 1.235 | 1.102 | −0.132 | −10.71 | 6.04 | 1.25 |
| Y2 | 1.108 | 0.935 | −0.173 | −15.61 | 9.07 | 1.98 |

As can be seen in the data presented in Tables 4A to 4C, though the data is good for the various ink compositions printed on the three different fabric substrates, the Jacquard cotton (treated) performed generally better than the gray cotton (untreated), and the gray cotton performed generally better than the silk (untreated). Furthermore, the Jantex™ 924, which has a slightly higher acid number than Jantex™ 45NRF, provided slightly better washfastness than the Jantex™ 45NRF on the gray cotton.

### Example 4—Comparative with Commercially Available Fabric Printing Systems

The data from Table 4, which was generated on Jacquard cotton (with analog treatment), was compared against print samples generated on the same type of fabric substrate, provided by a print service provider (PSP), using Artistri® 5000 textile ink compositions (from DuPont, USA) and Lario/Digistar™ K-Choice digital ink compositions (from Kiian Digital, Germany). The data for the comparative samples was collected and calculated in the same manner as described in Example 3. The comparative data is provided in Table 5 below.

TABLE 5
Washfastness Comparative

| Ink Composition | Color | ΔE_{CIE} |
|---|---|---|
| Artistri ® | K | 2.45 |
| (DuPont) | C | 2.07 |
| | M | 2.55 |
| | Y | 10.17 |
| Lario/Digistar ™ K-Choice | K | 2.47 |
| (Kiian) | C | 2.04 |
| | M | 1.92 |
| | Y | 1.49 |
| Table 4A Ink Set | K1 | 1.61 |
| | C1 | 1.57 |
| | M1 or M2 | 1.46 or 1.12 |
| | Y1 or M2 | 1.08 or 1.81 |

As can be seen in Table 5, the ink sets assembled in Table 4A (from Example 1) provided better washfastness performance than Artistri® ink compositions, and also provided similar performance relative to Digistar™ K-Choice ink compositions. Notably, the ink compositions of the present disclosure are formulated to be suitable for ejecting from thermal inkjet printheads, which can be less expensive to operate than piezo printing systems or other analog printing systems.

While the present technology has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. An aqueous ink composition, comprising:
from 60 wt % to 90 wt % water;
from 4 wt % to 30 wt % organic co-solvent;
from 1 wt % to 6 wt % pigment having a styrene acrylic polymer dispersant associated with a surface of the pigment, the styrene acrylic polymer dispersant having a weight average molecular weight from 1,000 Mw to 50,000 Mw; and
from 3 wt % to 15 wt % styrene C3-C5 alkyl (meth)acrylic polymer binder having a weight average molecular weight from 100,000 Mw to 500,000 Mw.

2. The aqueous ink composition of claim 1, wherein the styrene acrylic polymer dispersant has a weight average molecular weight from 4,000 Mw to 30,000 Mw and an acid number from 100 mg/g to 350 mg/g.

3. The aqueous ink composition of claim 1, wherein the styrene C3-C5 alkyl (meth)acrylic polymer binder is a styrene butyl acrylic polymer binder and has an acid number from 5 mg/g to less than 100 mg/g.

4. The aqueous ink composition of claim 1, wherein the styrene C3-C5 alkyl (meth)acrylic polymer binder has an average particle size from 50 nm to 800 nm.

5. The aqueous ink composition of claim 1, further comprising from 0.1 wt % to 1.5 wt % of an anionic surfactant.

6. The aqueous ink composition of claim 5, wherein the anionic surfactant is a phosphate ester of a C10 to C20 alcohol.

7. A textile printing system, comprising:
an aqueous ink composition, including:
from 60 wt % to 90 wt % water,
from 4 wt % to 30 wt % organic co-solvent,
from 1 wt % to 6 wt % pigment having a styrene acrylic polymer dispersant associated with a surface of the pigment, wherein the styrene acrylic polymer dispersant has a weight average molecular weight from 1,000 Mw to 50,000 Mw, and
from 3 wt % to 15 wt % styrene C3-C5 alkyl (meth)acrylic polymer binder having a weight average molecular weight from 100,000 Mw to 500,000 Mw; and
a fabric substrate.

8. The printing system of claim 7, wherein the styrene acrylic polymer dispersant has a weight average molecular weight from 4,000 Mw to 30,000 Mw and an acid number from 100 mg/g to 350 mg/g.

9. The printing system of claim 7, wherein the styrene C3-C5 alkyl (meth)acrylic polymer binder is a styrene butyl acrylic polymer binder and has an acid number from 5 mg/g to less than 100 mg/g.

10. The printing system of claim 7, wherein the styrene C3-C5 alkyl (meth)acrylic polymer binder has an average particle size from 50 nm to 800 nm.

11. The printing system of claim 7, further comprising from 0.1 wt % to 1.5 wt % of a phosphate ester of a C10 to C20 alcohol.

12. The printing system of claim 7, wherein the fabric substrate is a natural fiber textile substrate.

13. A method of textile printing, comprising ejecting an aqueous ink composition onto a fabric substrate, wherein the aqueous ink composition comprises:
from 60 wt % to 90 wt % water,
from 4 wt % to 30 wt % organic co-solvent,
from 1 wt % to 6 wt % pigment having a styrene acrylic polymer dispersant associated with a surface of the pigment, wherein the styrene acrylic polymer dispersant has a weight average molecular weight from 1,000 Mw to 50,000 Mw, and
from 3 wt % to 15 wt % styrene C3-C5 alkyl (meth)acrylic polymer binder having a weight average molecular weight from 100,000 Mw to 500,000 Mw.

14. The method of claim 13, wherein the fabric substrate is a natural fiber textile substrate.

15. The method of claim 13, further comprising curing the aqueous ink composition on the fabric substrate at a temperature from 130° C. to 180° C. for from 1 to 5 minutes.
